(19) United States
(12) Patent Application Publication
(10) Pub. No.: US 2026/0249117 A1
(43) Pub. Date: Aug. 27, 2026

(54) DEVICE FOR GASEOUS FIRE EXTINCTION AND GAS-GENERATING COMPOSITION

(71) Applicant: EXTINGUISHING SYSTEMS LIMITED LIABILITY COMPANY, Sankt-Peterburg (RU)

(72) Inventors: Sergei Nikolaevich LUKIANOV, Sankt-Peterburg (RU); Dmitrii Georgievich ARTAMONOV, Sankt-Peterburg (RU); Andrei Borisovich ZHDANOVICH, Sankt-Peterburg (RU); Dmitrii Viktorovich PEKSHIN, Sankt-Peterburg (RU); Vadim Vladimirovich KOLCHIN, Sankt-Peterburg (RU); Evgenii Pavlovich IAKIMOV, Sankt-Peterburg (RU); Vladimir Gennadevich DEMIDOV, Sankt-Peterburg (RU); Sergei Nikolaevich BAEV, Moscow (RU); Elena Pavlovna CHASHCHINA, Moscow (RU)

(73) Assignee: EXTINGUISHING SYSTEMS LIMITED LIABILITY COMPANY, Sankt-Peterburg (RU)

(21) Appl. No.: 18/870,412

(22) PCT Filed: May 29, 2023
(86) PCT No.: PCT/RU2023/000156

§ 371 Date: Nov. 28, 2024

(30) Foreign Application Priority Data
May 30, 2022 (RU) 2022114525
Dec. 28, 2022 (RU) 2022134775

(51) Int. Cl. A62C 13/00; A62C 13/20; A62C 13/76

(52) U.S. Cl. CPC A62C 13/003; A62C 13/20; A62C 13/76

(57) ABSTRACT

This group of inventions relates to the fire suppression field, namely to devices that generate fire-extinguishing gas (a mixture of gases) by burning compositions to produce fire-extinguishing gas (a mixture of gases) without ozone depleting substances. Inventions may be used as autonomous devices to extinguish fires in conventionally sealed spaces and to make other devices using such gas or a mixture of gases to build pressure inside a reservoir (a module) to displace the fire extinguishing substance: powder, water or aqueous solutions and other compositions.

The first version of the device with radial leakage of gas and the second version of the device with axial leakage of gas. In the first version of the design, the gas fire suppression device comprises a cylindrical casing with a bottom, a cover and holes for fire extinguishing gas release, a gas generating charge and a start assembly, the casing is equipped with a cassette containing a cylindrical shell, which is permeable for the gaseous combustion products, and a blind bottom. The cassette is joined to the cover and is installed so that a circular clearance is formed between the casing and the cassette, and the gas generating charge is installed inside the cassette, besides, the holes for fire extinguishing gas are placed in the cylindrical wall of the casing. The cassette is equipped with a filtering shell fixed from the outside, and the blind bottom of the cassette is made as capable of detachable connection with the cylindrical shell and is equipped with two circular ledges on the outer surface, the outer and the inner ones, besides, between the outer circular ledge of the cassette bottom and the circular ledge on the bottom there is a circular clearance arranged. Besides, a gas generating composition is proposed as used in the device.

The technical result is expansion of the field of application by the option of using both in the form of fire suppression devices generating fire extinguishing gas (a mixture of gases) and designed to extinguish fires of A2, B and C class, and for the systems of fluid and powdered substances purge, as well as for activation of the sol and gel formation process when making a quick-hardening fire extinguishing foam based on foamed hydrogel of silicic acid. The additional technical result consists in enabling production of higher degree of combustion products treatment from finely dispersed phase with the simplified technology of device manufacturing and ensuring convenient operation.

### PERTINENT ART

This group of inventions relates to the fire suppression field, namely to devices that generate fire-extinguishing gas (a mixture of gases) by burning compositions to produce fire-extinguishing gas (a mixture of gases) without ozone depleting substances. Inventions may be used as autonomous devices to extinguish fires in conventionally sealed spaces and to make other devices using such gas or a mixture of gases to build pressure inside a reservoir (a module) to displace the fire extinguishing substance: powder, water or aqueous solutions and other compositions.

### PRIOR ART

A prior gas fire suppression device is known (patent RU 2465937 C1 published on Nov. 10, 2012) that relates to low temperature solid fuel devices generating an inert mixture of gases and that may be used as an autonomous gas fire suppression device in confined spaces. The prior gas fire suppression device contains an igniter, a charge of non-azide gas generating composition based on a mixture of potassium nitrate and ammonia nitrate with a central blind hole, where the weighed portion of the igniting mixture is placed, a cooling filter made of pelletized or granulated sodium bicarbonate and installed in a cylindrical casing with a cover tightly fixed thereto. Besides, the cover is fixed in the end of the cylindrical casing of the device opposite to the bottom with a hole for fire-extinguishing gas release, the charge is made as a monoblock or at least as two sticks, the charge body has holes arranged in rows on its side surface evenly along its height and closed by explosive elements, and its bottom is made as plugged. Besides, at the bottom the device is provided with a separating filter isolated from the cooling filter by a metal mesh, installed in the device casing with a clearance and made of corrugated filtering paper rolled in a cylinder, and internal and external side surfaces of which are provided with metal meshes, and the ends are provided with an upper blind metal mesh and a lower metal mesh with a central hole, besides, the mesh limiting the separating filter along the external side surface is glued over with a gas impermeable fabric. Downstream the separating filter, a disk is installed with a thinning or a hole in the central part, a closed explosive element, pressed with the help of a washer by a clamping nut to the device casing bottom neck, and the cooling filter is placed to fill the entire free internal space of the device casing, and the ratio between the charge gas generating composition components is chosen to provide oxygen balance close to zero.

The gas fire suppression device of patent RU 2465937 has the following disadvantages.

The first disadvantage is that the device of patent RU 2465937 by its characteristics is substantially an aerosol fire suppression device, since not only gases (nitrogen, carbon dioxide) and water vapors participate in the suppression process as specified in the description, but condensed solid particles as well.

The boundary between the aerosol and gas fire suppression devices may be defined using the values of the suppression capability of substances generated by the devices.

The following reference (see in Table 1.7): V. V. Agafonov, N. P. Kopylov Aerosol fire suppression units design, installation and operation issues. Guidance manual/Edited by N. P. Kopylov-M: Fire Safety Research Institute, 2001-115 p. contains data on comparison of suppression capability of gas fire-extinguishing substances, including nitrogen and carbon dioxide, with suppression capability of aerosol generating compositions (AGCs):

TABLE 1
Comparison of suppression capability of substances

| | Halo | Halo | | Carbon | | |
|---|---|---|---|---|---|---|
| Fire-extinguishing | carbon | carbon | Nitrogen | dioxide | Powder | |
| substance | 114B2 | 13B1 | N₂ | CO₂ | PSB-3 | AGS |
| Suppression capability of fire | 0.23-0.37 | 0.33 | 0.6-0.8 | 0.6-0.7 | 0.5-0.7 | 0.04-0.06 |
| extinguishing agent, kg/m³ | | | | | | |

Appendix D of regulation: SP 485.13500.2020 Fire protection systems. Automatic fire suppression units. Norms and rules of design: approved and enacted by the order of the Ministry of the Russian Federation for Civil Defense, Emergency Management and Natural Disasters Response dated Aug. 31, 2020 No. 628: date of enactment Mar. 1, 2021, registered by the Federal Technical Regulation and Metrology Agency on Oct. 7, 2020/e-resource of the Federal Technical Regulation and Metrology Agency: [website]. —URL: https://protect.gost.ru/document.aspx?control=7&baseC=101&RegNum=54&DocOnPageCou nt=15&page=21&id=239355 (accessed on: 13.12.2022), provides the normative fire-extinguishing concentrations when extinguishing various substances, for gases in volume percents. Their recalculation to mass concentrations in kg/m³ is given in Table 2.

TABLE 2
Normative fire-extinguishing concentrations of gases when extinguishing various substances

| | | Normative fire-extinguishing concentration | | | | | | | |
|---|---|---|---|---|---|---|---|---|---|
| | Gas density, | Heptane | | Ethanol | | Benzene | | Oil | |
| Gas | kg/m³ | vol. % | kg/m³ | vol. % | kg/m³ | vol. % | kg/m³ | vol. % | kg/m³ |
| Nitrogen | 1.17 | 34.6 | 0.405 | 36 | 0.421 | 33.8 | 0.395 | 27.8 | 0.325 |
| Argon | 1.66 | 39 | 0.647 | 46.8 | 0.777 | 44.3 | 0.735 | 36.1 | 0.599 |
| CO₂ | 1.88 | 34.9 | 0.656 | 35.7 | 0.671 | | | | |
| SF₆ | 6.474 | 10 | 0.647 | 14.4 | 0.932 | | | 7.2 | 0.466 |
| Halo carbon | 2.93 | 14.6 | 0.428 | | | | | | |
| 123 CF₃H | | | | | | | | | |
| Halo carbon | 5.208 | 9.8 | 0.510 | 11.7 | 0.609 | | | 9.5 | 0.495 |
| 125 C₂F₅H | | | | | | | | | |
| Halo carbon | 7.85 | 7.2 | 0.565 | | | 6.7 | 0.526 | | |
| 218 C₃F₈ | | | | | | | | | |
| Halo carbon | 7.28 | 7.2 | 0.532 | | | 7.3 | 0.531 | | |
| 227ea C₃F₇H | | | | | | | | | |

According to the description of invention RU 2465937, when tests were performed in the space of 1 m³, fire sources were extinguished with gas generating composition mass of 240 g (0.24 kg), i.e. the fire extinguishing concentration was 0.240 kg/m³. This value is significantly lower than the fire extinguishing concentrations of nitrogen and carbon dioxide (Table 2), which, according to invention RU 2465937, are used to extinguish. Extinguishing with carbon dioxide and nitrogen is carried out by diluting air in the protected space and reducing its oxygen concentration to the level that will not sustain combustion. Other extinguishing mechanisms that include cooldown and inhibition of chain reactions of combustion are not inherent in these gases. Therefore, if the value of the fire extinguishing concentration turned out to be lower than the one that induces extinguishing for each gas separately (for N₂ 0.240<0.405 and for CO₂ 0.240<0.656), it is necessary to check the proportion of all fire extinguishing gases in the mixture with the air in the protected space.

It will be possible to check this, if the composition of the gas fire extinguishing substance is known. This composition is published on the official website of the patent holder, JSC Source Plus, at URL: https://antifire.org/wp-content/uploads/2022/08/Pasport-GGPT-1-s-izm.pdf, in the data sheet for the gas extinguishing generators GGPT-1.0, the design layout of which (FIGS. 1 and 2) is made based on patent RU 2465937.

TABLE 3
Composition of gas fire extinguishing substance (RU 2465937)

| Component | Content, vol. % |
|---|---|
| CO₂ | 37.5 |
| N₂ | 22.5 |
| CO | 7.4 |
| H₂ | 3.0 |
| H₂O | 29.1 |
| O₂ | 0.2 |
| CH₄ | 0.3 |

For GGPT-1.0 generator the mass of the gas generating composition is 0.25 kg. Providing that only gas is produced from combustion of this solid composition, and there are no solid particles, it is possible to calculate the volume fractions of components when the fire extinguishing gas is mixed with air, the weight of which in 1 m³ is 1.2041 kg (0.25 kg of gas is mixed with 1.2041 kg of air). The results of this calculation for fire extinguishing gases CO₂, N₂ and water vapors are given in Table 4.

TABLE 4
Comparative analysis of fire extinguishing gases content
in air of protected space during operation of generator
under patent RU 2465937 and content of fire extinguishing
gases, when extinguishing happens

| Fire | Content in air during | Content, when |
|---|---|---|
| extinguishing | operation of generator under | extinguishing |
| gas | patent RU 2465937, vol. % | happens, vol. % |
| CO₂ | 6.2 | 34.5 |
| N₂ | 3.72 | 34.6 |
| H₂O (vapor) | 4.82 | 35.0 |
| | Total: 14.74% | — |

From Table 4 you can see that concentration of fire extinguishing gases supplied to the protected space by the device under patent RU 2465937, both separately and altogether, is significantly lower than that providing for extinguishing.

If the volume fraction of oxygen in the mixture containing 1 m³ of air and combustion products of the gas generating composition with weight of 0.25 kg is calculated, it will appear that this fraction would be 17.5%. The reduction of the oxygen volume fraction down to 17.5% is not sufficient to terminate combustion. The volume fraction of oxygen should be reduced to at least 16%.

The completed calculations demonstrate that extinguishing with gases produced during operation of the device under patent RU 2465937 may not be provided by dilution (reduction of oxygen content in the protected space), and carbon dioxide and nitrogen have no inhibiting properties. Therefore, two other extinguishing processes remain-inhibition of reactions in the flame with active solid particles, which are not retained by the device filters and cooldown with the drops of finely pulverized water.

Considering the fact that the stated values of the fire extinguishing concentration take the intermediate position between aerosol and gas devices, the device under patent RU 2465937 may be related to generators of fire extinguishing aerosol with partial removal of solid particles (with reduced content of solid particles).

Another disadvantage is due to the fact that to avoid exposure of the paper separating filter to high temperature of combustion products, the latter must be cooled down by passage through a layer of sodium bicarbonate, which results in significant increase of weight and dimensions of the unit. Besides, interaction of sodium bicarbonate and combustion products causes additional ingress of water vapors in the protected space, which is an unfavorable factor in protection of cabinets with electric and electronic equipment.

A prototype of the suggested versions of the gas fire suppression devices (claims 1 and 6) is a gas fire suppression devices disclosed in patent RU 2640466, published on Jan. 9, 2018. The prior device comprises an outer metal cylindrical casing tightly fixed through sealing with a cover, a charge of a solid chemical substance of non-azide gas generating composition with a central blind cylindrical hole made at the end facing the cover and an igniter both placed inside the casing, and a flat elastic element is installed between the cover and the charge end. The outer metal casing is equipped with an inner perforated casing, fixed to the cover through sealing and installed to create a circular slot gas duct between the outer casing and the inner perforated casing. The charge of solid chemical substance of non-azide gas generating composition with a central blind cylindrical hole is made porous and gas permeable from substances and in a composition chosen depending on the the field of usage, and a granulated igniter is placed in its hole. Besides, the hole porous gas permeable gas generating charge is installed without a clearance inside the perforated casing by one end on the cover with the flat elastic element, and by the other end in a tin cartridge with a blind bottom, which the inner perforated casing is equipped with, and the outer metal casing is closed with a splitter plug with notches, and a tight interfacing assembly is placed on the cover from the outside.

The first disadvantage of this invention is the complexity of the device manufacturing technology caused by design features that provide for removal of finely dispersed solid particles from combustion products. The design additionally includes an inner perforated casing, which is joined with the outer casing by sealing to create an inner circular clearance. The sealing operation complicates the device manufacturing technology as it requires additional tools and accessories.

Besides, manufacturing of a charge with a narrow blind cylindrical hole to install an igniter presents significant technological difficulties. In accordance with the invention, such hole is necessary to provide for layered combustion of the porous charge from the inner surface towards the periphery and to maintain cocurrent filtration of combustion products passing through the porous layer.

The second disadvantage is inconvenience of operation since the igniter and the ignition initiator are not a separate replaceable assembly, but are installed inside the gas generating charge in the dead cylindrical hole. If the start circuit integrity is damaged, this will require replacement of the entire generator at the asset to be protected.

The third disadvantage is low efficiency of the perforated casing when finely dispersed solid particles are filtered.

The fourth disadvantage is the availability of the flat elastic element in the form of a rubber temperature vibration shock absorber that may become a source of toxic gases as a result of thermal destruction caused by high temperature from charge combustion.

Invention under patent RU 2640466 published on Jan. 9, 2018 is known, which discloses a non-azide gas generating composition containing novolac phenol-formaldehyde resin, potassium nitrate, basic magnesium carbonate, carbamide and graphite in the required ratio. The specified composition is used to shape a channel porous gas permeable charge to be used within the gas generating device that enables a layered rather than volume combustion process initiated by a manmade pressure drop between the initial surface, the ignition surface and the final surface, the surface of generated gas leakage from the initial charge.

The disadvantage of this invention is the fact that special conditions are necessary for the specified composition to function that the charge made of it must have, for example, presence of through porosity and gas permeability, and a central blind cylindrical hole. The above disadvantage causes complication and higher costs of the technology to manufacture the gas generating charges as such and the gas generators based on them.

A flame retardant composition known from patent RU 2610120 published on Feb. 8, 2017 contains a compound selected from copper salts in the amount of 30 to 95 wt %, and a fire proof component in the amount of 5 to 70 wt %. A pyrotechnical compound serves as a source of heat and energy in this composition, and burns after being ignited, creating high temperature providing for the composition decay reaction, which enables spraying, together with the pyrotechnical compound, a large quantity of flame retardant substances produced as a result of the reaction with the purpose of fire suppression. The flame retardant composition based on copper salts may quickly and effectively reduce the amount of heat released from combustion of the pyrotechnical compound; to significantly reduce the temperature of sprayed substances and to eliminate the need for using complicated cooldown systems in the fire suppression device.

The main disadvantage of this invention is the fact that the specified composition may not be used as a source to produce a “pure” fire extinguishing gas, since gas generated from its combustion contains quite many solid combustion products (for example, potassium carbonate).

The closest analog to the invention proposed under claim 12 is the invention under patent RU 2151135 C1, Jun. 20, 2000, which relates to formulas of gas generating compositions for use in the systems of fluid and powdered substances purge. A gas generating composition contains potassium nitrate, phenol-formaldehyde resin, basic magnesium carbonate and ammonia oxalate monohydrate at the following ratio of components, wt %: potassium nitrate 54.0-60.0; novolac phenol-formaldehyde resin 15.0-24.0; basic magnesium carbonate 5.0-17.0; ammonia oxalate monohydrate 5.0-20.0. As specified in the source, the composition has high performance characteristics: low temperature of produced gases and high specific gas efficiency, and provides for reliable functioning of the gas generator in the temperature range from minus 50 to plus 50° C.

The disadvantages of the closest analog is the fact that it is not possible to use the specified gas generating composition to produce fire extinguishing gas, since the produced gas includes methane (more than 0.05 mole fractions (mole %) and water vapors (0.28-0.35 mole %) and contains a small quantity of carbon dioxide (0.16 mole % max.), which in its turn restricts the area of using this gas generating composition to only blow and purge the fluid and powdered substances.

### Invention Disclosure

The objective that the group of inventions aims to solve consists in development of a gas fire suppression device with a charge from pyrotechnical composition that generates a mixture of fire extinguishing gases, such as carbon dioxide, nitrogen and vaporous water, with high degree of combustion products treatment from finely dispersed condensed solid parties, with a simple manufacturing technology and convenient to operate within gas fire extinguishing units.

The technical result is expansion of the field of application by the option of using both in the form of fire suppression devices generating fire extinguishing gas (a mixture of gases) and designed to extinguish fires of A2, B and C class, and for the systems of fluid and powdered substances purge, as well as for activation of the sol and gel formation process when making a quick-hardening fire extinguishing foam based on foamed hydrogel of silicic acid.

The additional technical result consists in enabling production of higher degree of combustion products treatment from finely dispersed phase with the simplified technology of manufacturing and ensuring convenient operation.

To solve the objective and to provide for the technical result, two design options are proposed for the gas fire suppression device with radial (claim 1) and axial (claim 6) gas leakage, and a gas generating composition (claim 12) designed for use in the specified devices.

In the first version of the design, the gas fire suppression device comprises a cylindrical casing with a bottom, a cover and holes for fire extinguishing gas release, a gas generating charge and a start assembly, the casing is equipped with a cassette containing a cylindrical shell, which is permeable for the gaseous combustion products, and a blind bottom. The cassette is joined to the cover and is installed so that a circular clearance is formed between the casing and the cassette, and the gas generating charge is installed inside the cassette, besides, the holes for fire extinguishing gas are placed in the cylindrical wall of the casing. The cassette is equipped with a filtering shell fixed from the outside, and the blind bottom of the cassette is made as capable of detachable connection with the cylindrical shell and is equipped with two circular ledges on the outer surface, the outer and the inner ones, besides, between the outer circular ledge of the cassette bottom and the circular ledge on the bottom there is a circular clearance arranged.

In the second version of the design, the gas fire suppression device comprises a cylindrical casing with a bottom, a cover and holes for fire extinguishing gas release arranged in the bottom, a charge of gas generating composition and a start assembly, the casing is equipped with a cassette, comprising a cylindrical shell permeable for gaseous charge combustion products, and a blind bottom, the cassette is connected to the cover and is installed so that a circular clearance is formed between the device casing and the cassette, and the gas generating charge is installed inside the cassette. Besides, the cassette is equipped with a filtering shell fixed from the outside, the blind bottom of the cassette is made as capable of detachable connection with the cylindrical shell and is equipped with two circular ledges on the outer surface, the outer and the inner ones, besides, the device comprises a perforated disk, on the surface of which a circular ledge is arranged and installed in such a manner that between the outer circular ledge of the cassette bottom and the circular ledge on the perforated disk there is a circular clearance arranged.

The device in the second version of the design may additionally contain a cooling filter installed between the perforated disk and a cap that contacts with the bottom.

In any version of the device design the filtering shell may be made of a fabric resistant to high temperature exposure, for example, siliceous fabric. The first elastic element is installed between the cover and the charge, and the second elastic element is installed between the inner circular ledge of the cassette bottom and the circular ledge of the perforated disk. The outer circular ledge of the cassette blind bottom has technological holes to ensure its detachable (for example, threaded) connection with the cylindrical shell of the cassette.

Besides, a gas generating composition is proposed, which is designed for use in the above devices, and contains a gas generating agent, potassium nitrate and novolac phenol-formaldehyde resin as a flammable binder, besides, the gas generating agent is metal oxalate with mixed valence at the following ratio of components, wt %:

| | |
|---|---|
| metal oxalate with mixed valence | 32.0-70.0 |
| potassium nitrate | 25.0-54.0 |
| novolac phenol-formaldehyde resin | 5.0-14.0. |

### BRIEF DESCRIPTION OF DRAWINGS

The proposed group of inventions is illustrated by drawings.

FIG. 1 presents the general view of the design version of a gas fire suppression device with radial gas leakage.

FIG. 2 shows the general view of the design version of a gas fire suppression device with axial gas leakage.

FIG. 3 shows a photo of a gas generating composition stick in process of combustion.

FIG. 4 presents a photo of a glowing gas generating composition stick immediately after combustion.

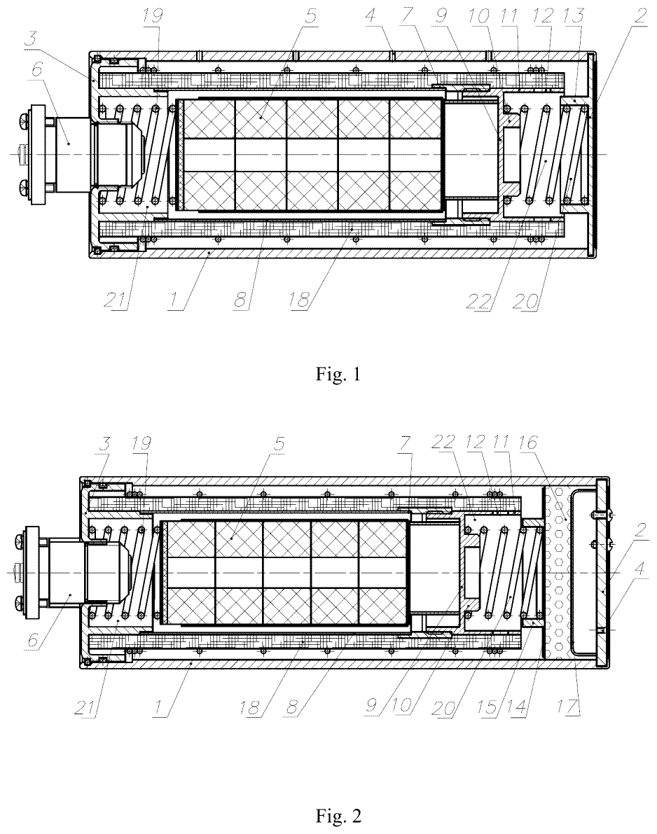

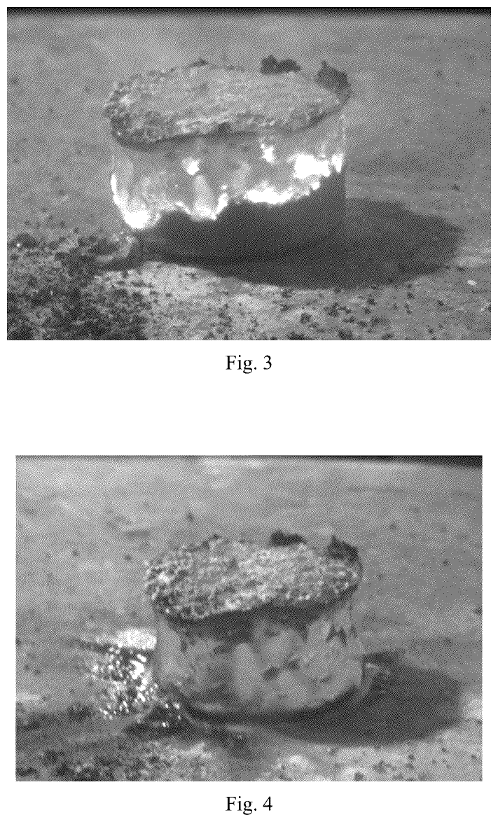

### INVENTION EMBODIMENTS

In the first version of design (with radial gas leakage) the gas fire suppression device contains a cylindrical casing 1 with a bottom 2, a cover 3 and holes 4 for fire extinguishing gas release, a gas generating charge 5 and a start assembly 6 made as capable of detachable connection with the cover 3. The casing 1 and its components may be made of metal or composite material. The casing 1 is equipped with a cassette 7 comprising a cylindrical shell 8, permeable for gaseous combustion products of the charge 5, and a blind bottom 9, the cassette 7 is connected to the cover 3 and is installed so that between the casing 1 and the cassette 7 there is a circular clearance, and the gas generating charge 5 is installed inside the cassette 7. Besides, holes 4 for fire extinguishing gas release are located in the cylindrical wall of the casing 1. Besides, the blind bottom 9 of the cassette 7 is made as capable of detachable connection with the cylindrical metal shell 8 and is equipped with two circular ledges on the outer surface—the outer 11 and the inner 10 ones, the outer ledge 11 has technological holes 12 to ensure the assembly of the threaded connection of the cassette and the bottom of the cassette, and on the inner side of the bottom 2 in the casing 1 there is a circular ledge 13. Besides, between the outer circular ledge 11 of the cassette 7 bottom and the circular ledge 13 on the bottom there is a circular clearance.

The gas fire suppression device of the second version of design (with axial gas leakage) contains a cylindrical casing 1 with a bottom 2, a cover 3 and holes 4 for fire extinguishing gas release, made in the bottom 2, a gas generating charge 5 and a start assembly 6. The casing 1 is equipped with a cassette 7 comprising a cylindrical shell 8, permeable for gaseous combustion products of the charge 5, and a blind bottom 9, the cassette 7 is connected to the cover 3 and is installed so that between the casing 1 and the cassette 7 there is a circular clearance, and the gas generating charge 5 is installed inside the cassette 7. The bottom 2 may be made of a flat metal sheet. Besides, the blind bottom 9 of the cassette 7 is made as capable of detachable connection with the cylindrical metal shell 8 and is equipped with two circular ledges on the outer surface—the outer 11 and the inner 10 ones, the outer ledge 11 has technological holes 12 to ensure the assembly of the threaded connection of the cassette and the bottom of the cassette. Besides, the device comprises a perforated disk 14, on the surface of which there is a circular ledge 15 installed so that between the outer circular ledge of the cassette bottom 11 and the circular ledge 15 on the perforated disk 14 there is a circular clearance. The device additionally contains a cooling filter 16 in the form of a pelleted cooler (for example, based on a basic magnesium carbonate) installed between the perforated disk 14 and the cap 17 that contacts with the bottom 2. The start assembly 6 comprising, for example, an electric igniter, is connected through detachable connection with the cover 3. In particular case the charge may be ignited using an intermediate stick installed between the start assembly 5 and the charge 6. The device may be additionally equipped with an attachment—a gas duct (not shown), installed on the side of the bottom 2.

In any version of the device design the cassette may be equipped with a filtering shell 18 fixed from the outside and made of one or several layers (from 1 to 5) of fabric resistant to high temperature exposure, for example, of high temperature siliceous fabric of satin webbing, grade KT-11.S 8/3 TO. From the outside of the bottom the holes 4 for gas release may be closed with a self-adhesive film with a warning inscription.

The first elastic element 19 is placed between the cover 3 and the charge 5, and the second elastic element 20 is placed between the inner circular ledge 10 of the bottom 9 in the cassette 7 and the circular ledge 13 on the bottom 2 of the casing 1 or the circular ledge 15 on the perforated disk 14. Elastic elements 19, 20 perform several functions. The first elastic element 19 provides for orientation and prevents displacement of charge 5 inside the cassette 7, and participates in formation of free space 21 inside the cassette 7 to ensure effective combustion of charge 5. The second elastic element 20 is installed to prevent displacement of the cassette 7 relative to the central axis of the casing 1 (in other words, to maintain the permanent value of the circular clearance between the casing 1 and the cassette 7) and participates in formation of free space inside the casing 1 in the form of a buffer chamber 22, the presence of which, in combination with the circular clearances provided for by the design, provides for leveling of the gas flow and its even release via the holes 4 for fire extinguishing gas release. The elastic elements 19, 20 may be compression or flexure springs, etc.

The device made under any of the invention versions operates as follows. When an electric pulse is sent from the start assembly 6, the charge 6 from the gas generating composition ignites. Combustion products, passing through the gas permeable shell 8 of the cassette 7 and additionally through the filtering shell 18 and the cooling filter 16 (if there is one) are cleaned from solid microparticles. Further the cleaned fire extinguishing gas moves in the circular clearances and exits via the holes in the cylindrical wall or in the bottom of the casing in the protected space. As a result, the concentration of oxygen in the protected space drops down to the level, when the fire outbreaks stop burning.

Making the cassette bottom capable of detachable connection with the cylindrical shell simplifies the device manufacturing technology, since compared to the prototype it excludes the need for the sealing operation to install the inner perforated casing and to form the circular clearance, which requires use of the additional tools and accessories. Circular ledges provide for convenience of the elastic element installation during the assembly, and the circular clearance between the outer circular ledge of the cassette bottom and the circular ledge on the bottom facilitates installation of the cassette in the generator casing with a symmetric circular clearance between the cassette and the inner surface of the device casing, the presence of which provides for leveling of the gas flow and its even release via the holes for fire extinguishing gas release.

Introduction of a filtering shell made of fabric resistant to high temperature exposure, for example, siliceous fabric, into the device design to be fixed on the outside of the cassette, provides for higher degree of the combustion products treatment from finely dispersed solid particles compared to the inner perforated casing. In the prototype the treatment of the combustion products from condensed fluid and solid particles is substantially two-stage: first the combustion products pass through the porous layer of the charge, since the combustion happens from the inner surface towards the periphery, and then through the inner perforated casing. Such method of treatment requires making a charge with a blind narrow cylindrical hole, which is technologically complicated, as a result the whole design of the prototype is technologically complicated to make. In the proposed solution the filtering shell of fabric resistant to high temperature exposure will not only provide for higher degree of treatment, but will also simplify the technology for making the design, since it may apply a solid fuel charge of a simple and easy to make shape, for example, in the form of cylindrical single-channel sticks.

Use of metal elastic elements in the proposed device to fix the cassette with the charge and to protect it against vibration load instead of an elastic rubber shock absorber makes it possible to avoid release of toxic gases as a result of thermal destruction.

Use of the start assembly in the form of a separate replaceable assembly in the design of the proposed device provides for convenient operation of the device, since in case of violated integrity of the start circuit this assembly may easily be replaced, without resorting to full replacement of the device at the asset to be protected.

The tests completed to extinguish model fire outbreaks and to assess the degree of combustion products treatment from finely dispersed solid particles confirmed the ability of practical realization of the proposed technical solutions.

The tests of the proposed versions of the device for extinguishing the model fire outbreaks of n-heptane according to GOST R 53280.3-2009 were carried out in a conventionally tight space. Model outbreaks were extinguished, and oxygen concentration in the protected space reduced down to 14.76-14.95 vol % for the version with radial leakage and down to 15.26 vol % for the version with axial leakage, which confirms the mechanism of gas extinguishing by reduction of oxygen content in the protected space down to the level that will not sustain combustion.

A gas generating charge may be made of usually non-azide compositions that contain, in particular, potassium nitrate, a binder and other components, including gas generating agents, which burn to produce mostly the following combustion products: carbon oxide (more than 60%), water vapors, nitrogen. Combustion products are not highly toxic and do not contain ozone depleting substances.

The gas generating agent is metal oxalates with mixed valence, for example, nickel oxalate dihydrate NiC₂O₄: 2H₂O, copper oxalate hemihydrate CuC₂O₄·0.5H₂O, cobalt oxalate dihydrate CoC₂O₄·2H₂O, ferric oxalate (III) pentahydrate Fe₂ (C₂O₄)₃·5H₂O, magnesium oxalate dihydrate MgC₂O₄·2H₂O, calcium oxalate monohydrate CaC₂O₄·H₂O, mostly copper oxalate hemihydrate.

The properties of metal oxalates with mixed valence are shown in Table 5.

The examples of embodiment of one of the proposed inventions—a gas generating composition, with specification of the combustion products, are shown in Table 6.

TABLE 5
Properties of metal oxalates with mixed valence

| | | | Temperature | | | |
|---|---|---|---|---|---|---|
| | | | range of | | Decomposition | |
| | | | decomposition | Estimated | products | Melt |
| Item | Chemical | M, | reaction, | mass | (without CO₂ | temperature, |
| No. | formula | g/mole | ° C. | loss, % | and H₂O) | ° C. |
| 1 | NiC₂O₄•2H₂O | 182.7 | 370-450 | 67.7 | NiO | 1955 |
| 2 | CuC₂O₄•0.5H₂O | 160.55 | 290-320 | 60.2 | Cu | 1084.62 |
| 3 | CoC₂O₄•2H₂O | 183 | 370-430 | 62 | Co/Co₃O₄ | 1495/900 (at 900° |
| | | | | | | C. melts with |
| | | | | | | decomposition) |
| 4 | Fe₂(C₂O₄)₃•5H₂O | 465.7 | 300-420 | 68.5 | Fe/Fe₃O₄ | 1538/1597 |
| 5 | MgC₂O₄•2H₂O | 148.3 | 450-550 | 72.6 | MgO | 2825 |
| 6 | CaC₂O₄•H₂O | 146 | 700-880 | 61.5 | CaO | 2613 |

TABLE 6
Examples of embodiment of gas generating composition
with specification of composition combustion products

| | Example | | | | | |
|---|---|---|---|---|---|---|
| Parameter | 1 | 2 | 3 | 4 | 5 | 6 |
| KNO₃, wt % | 31 | 38 | 25 | 54 | 50 | 54 |
| Iditol (novolac phenol- | 7 | 10 | 5 | 12 | 9 | 14 |
| formaldehyde resin), wt % | | | | | | |
| NiC₂O₄•2H₂O, wt % | | | | 34 | | |
| CuC₂O₄•0.5H₂O, wt % | 62 | 52 | 70 | | | |
| CoC₂O₄•2H₂O, wt % | | | | | 41 | |
| Fe₂(C₂O₄)₃•5H₂O, wt % | | | | | | 32 |
| Excess oxidant ratio | 0.80 | 0.75 | 0.83 | 0.8 | 0.88 | 0.75 |
| Firing temperature, K | 1186 | 1188.9 | 1158.4 | 1315.5 | 1345.6 | 1178.2 |
| CO₂, mole % T = 473K | 0.44 | 0.38 | 0.48 | 0.31 | 0.31 | 0.27 |
| CO, mole % T = 473K | 0.68 · 10⁻⁵ | 0.61 · 10⁻⁵ | 0.72 · 10⁻⁵ | 0.58 · 10⁻⁵ | 0.57 · 10⁻⁵ | 0.54 · 10⁻⁵ |
| H₂O, mole % T = 473K | 0.18 | 0.19 | 0.17 | 0.29 | 0.3 | 0.29 |
| N₂, mole % T = 473K | 0.07 | 0.08 | 0.06 | 0.12 | 0.12 | 0.12 |
| Condensed phase, mole % | Cu 0.18 | Cu 0.15 | Cu 0.21 | Ni 0.08 | Co₃O₄ 0.11 | Fe₃O₄ 0.02 |
| T = 473K | C 0.05 | C 0.11 | C 0.02 | C 0.07 | C 0.04 | C 0.16 |
| | K₂CO₃ 0.07 | K₂CO₃ 0.09 | K₂CO₃ 0.06 | K₂CO₃ 0.12 | K₂CO₃ 0.12 | K₂CO₃ 0.12 |

To make the proposed composition, the methods and equipment of prior art are used. Powders of the composition ingredients are mixed at the ratio specified in the examples (Table 6), any mixer may be used to mix. Then the mixture of powders is shaped in a die mold and compacted to the required density. After shaping the composition is exposed to heat treatment, the time and temperature are selected depending on the grade of the phenol-formaldehyde resin.

As you can see from the examples of invention embodiment (Table 6), the combustion of the proposed composition produces a significant quantity of CO₂ carbon dioxide quantity, which provides for using the composition not only in the devices using a mixture of gases to build up pressure inside the reservoir (module) and to purge the fire extinguishing substance, but in the devices of fire suppression using the generated fire extinguishing gas. We also note that the combustion of the proposed composition produces only traces, 0.68·10⁻⁵ mole fractions max., of carbon oxide (CO), which provides for safety of using fire suppression devices with such composition.

The examples show that the highest quantity of the target fire extinguishing gas, namely CO₂, is produced by compositions based on copper oxalate hemihydrate. Besides, in examples 1, 2, 3 the quantity of water vapors is 1.5 times lower than the quantity of water vapors in examples 4, 5, 6, despite the fact that the content of the gas generating agent is approximately 1.5-2 times higher. Therefore, the composition based on copper oxalate hemihydrate may be used in the areas, where it is not only required to suppress a fire, but also to do minimum damage to the protected equipment, for example, to extinguish microelectronics. An additional advantage of the composition (examples 1-3) based on copper oxalate hemihydrate is the fact that their firing temperature (Example 1-913° C.) is close to melt temperature of the produced condensed phase, which at the excess oxidant ratio is less then one consists mostly of pure copper (copper melt temperature is 1084.62° C.). In process of this composition combustion the produced copper particles soften and melt to interact with each other and form a highly porous skeleton acting as a filter from small quantities of solid particles of carbon and potassium carbonate produced in process of combustion.

The charges of the proposed composition were tested in the fire suppression devices that generate fire extinguishing gas (gas generators), in kitchen appliances fire suppression modules, and in systems for production of quick-hardening fire extinguishing foam based on a foamed hydrogel of silicic acid. Procedures and results of tests of the gas generating composition made according to example 1 are given as examples.

The charge from the proposed gas generating composition was placed in the fire suppression devices that generate a fire extinguishing gas. A charge was used, made of 10 sticks with a through cylindrical channel of 12 mm diameter. The specified device was installed in the right test chamber with volume of 0.5 m³, where a model fire outbreak was also arranged. In the first case they used a class A2 outbreak, which was a plate of organic glass (polymethyl methacrylate) with size of 105×20×10 (L×W×H), in the second case—a class B outbreak being a steel flat bowl with n-heptane with diameter of 80 mm, in the third case—a portable gas burner (a class C model outbreak). After the prior combustion of the model outbreak, which for classes A2, B and C was 30, 30 and 5 seconds accordingly, the test chamber door was closed, and a gas generator was started using a pyrotechnical start assembly. The flame of model outbreaks A2, B and C was put out in 20, 25 and 6 seconds accordingly after the start of the gas generator operation. The process of model outbreak combustion termination was confirmed visually via a sight glass in the test chamber. The fire extinguishing concentration by charge mass loss was 495 g/m³ in all three tests, which is close to the normative fire extinguishing concentration of pure CO₂ to extinguish fires of solid non-smoldering materials (class A2 fire) and n-heptane, which is 34.9 vol. % or in terms of mass concentration 637.2 g/m³ (https://gazoanalizators.ru/converter/). This fact in the minor difference of concentrations is due to presence of nitrogen and water vapors in the gas phase of proposed composition combustion products.

The charge from the proposed gas generating composition made of 3 sticks with a through cylindrical channel of 10 mm diameter was placed in a gas generator, which was then installed in the kitchen appliances fire extinguishing module filled with fire extinguishing fluid. Using a pyrotechnical start assembly, gas generator operation was initiated, in 3 seconds the pressure in the cylinder reached operating value, and a start membrane operated, having provided for spraying of the fire extinguishing fluid onto the model fire outbreak being burning vegetable oil. The time of fire extinguishing fluid release and gas generator operation was around 20 seconds. The model outbreak was suppressed within 10 seconds after the start of the fire extinguishing fluid spraying.

The charge from the proposed gas generating composition was placed in the fire extinguisher's gas generator to produce quick-hardening fire extinguishing foam based on a foamed hydrogel of siliceous acid (design of the fire extinguisher is disclosed in patent RU2749136 published on Jun. 4, 2021). The charge was made as a single channel-free stick insulated from the lower end and side surface using a heat resistant polymer material to ensure end combustion and to increase the gas generation time. After initiation of the gas generator combustion using the pyrotechnical start assembly, the generated gas (with high content of carbon oxide) along the pipelines was simultaneously supplied to purge the fluid component being a solution of alkaline metal silicate and hydrocarbon surfactant in water, and to activate the process of sol and gel formation of the specified fluid component to produce a foam mass at the outlet of the device that hardens within 10 seconds. The temperature of the released gases did not exceed plus 110° C., which is first of all due to the low combustion temperature of the proposed composition and also to use of chemical heat absorbers. Activation of the process of sol and gel formation of the fluid component in the quick-hardening fire extinguishing foam in this case is possible because of high content of CO₂ in the gas phase of the proposed composition combustion products.

1.-12. (canceled)

13. A gas fire suppression device, comprising:
a cylindrical casing (1) having
a cylindrical casing wall,
a bottom (2),
a cover (3), and
holes (4) for fire extinguishing gas release arranged in the cylindrical casing wall;
a gas generating charge (5) containing a gas generating composition;
a start assembly (6); and
a cassette (7), comprising
a cylindrical shell (8) permeable for gaseous charge combustion products, and
a blind bottom (9),
wherein the cassette (7) is attached to the cover (3) and arranged with a circular clearance in the cylindrical casing (1),
wherein the gas generating charge (5) is installed inside the cassette (7),
wherein the cassette (7) is equipped with a filtering shell (18) fixed on an outer surface of the cassette (7),
wherein the blind bottom (9) of the cassette (7) is detachably connected with the cylindrical shell (8) and is equipped with two circular ledges on an outer surface of the blind bottom (9),
wherein the two circular ledges include an outer circular ledge (11) and an inner circular ledge (10), and
wherein the outer circular ledge (11) is arranged with circular clearance from a further circular ledge (13) formed on the bottom (2) of the cylindrical casing (1).

14. The device according to claim 13,
wherein the filtering shell is made of siliceous fabric.

15. The device according to claim 13,
wherein the outer circular ledge of the blind bottom has technological holes.

16. The device according to claim 13,
wherein a first elastic element is placed between the cylindrical casing wall and the gas generating charge.

17. The device according to claim 13, further comprising
a second elastic element fixed between the inner circular ledge and the further circular ledge.

18. The device according to claim 13, wherein the gas generating composition comprises:
32-0-70.0 wt. % metal oxalate with mixed valence;
25.0-54.0 wt. % potassium nitrate; and
5.0-14.0 wt. % novolac phenol-formaldehyde resin.

19. A gas fire suppression device, comprising:
a cylindrical casing (1) having
a cylindrical casing wall,
a bottom (2),
a cover (3), and
holes (4) for fire extinguishing gas release arranged in the bottom (2);
a gas generating charge (5) containing a gas generating composition;
a start assembly (6);
a cassette (7), comprising
a cylindrical shell (8) permeable for gaseous charge combustion products, and
a blind bottom (9); and
a perforated disk (14);
wherein the cassette (7) is attached to the cover (3) and arranged with a circular clearance in the cylindrical casing (1),
wherein the gas generating charge (5) is installed inside the cassette (7),
wherein the cassette (7) is equipped with a filtering shell (18) fixed on an outer surface of the cassette (7),
wherein the blind bottom (9) of the cassette (7) is detachably connected with the cylindrical shell (8) and is equipped with two circular ledges on an outer surface of the blind bottom (9),
wherein the two circular ledges include an outer circular ledge (11) and an inner circular ledge (10),
wherein a further circular ledge (15) is arranged on a surface of the perforated disk (14), and
wherein the outer circular ledge (11) is arranged with circular clearance from the further circular ledge (15).

20. The device according to claim 19,
wherein the filtering shell is made of siliceous fabric.

21. The device according to claim 19,
wherein the outer circular ledge has technological holes.

22. The device according to claim 19,
wherein a first elastic element is placed between the cover and the gas generating charge.

23. The device according to claim 19, further comprising
a second elastic element located between the inner circular ledge and the further circular ledge of the perforated disk.

24. The device according to claim 23, further comprising
a cooling filter installed between the perforated disk and a cap that contacts with the bottom.

25. The device according to claim 19, wherein the gas generating composition comprises:
32-0-70.0 wt. % metal oxalate with mixed valence;
25.0-54.0 wt. % potassium nitrate; and
5.0-14.0 wt. % novolac phenol-formaldehyde resin.
